(19) United States
(12) Patent Application Publication
(10) Pub. No.: US 2023/0181294 A1
(43) Pub. Date: Jun. 15, 2023

(54) TOOTH-BORNE GUIDE PLATE, MUCOSA-BORNE GUIDE PLATE, BONE-BORNE GUIDE PLATE, AND PREPARATION AND APPLICATION METHODS THEREFOR

(71) Applicant: ZUGA MEDICAL CHENGDU CO., LTD, CHENGDU (CN)

(72) Inventors: CHAN Q. WANG, CHAGRIN FALLS, OH (US); ZHONGYU YU, CHENGDU (CN); YUE LI, CHENGDU (CN)

(73) Assignee: ZUGA MEDICAL CHENGDU CO., LTD, CHENGDU, SI (CN)

(21) Appl. No.: 17/625,034

(22) PCT Filed: Jun. 24, 2020
(86) PCT No.: PCT/CN2020/097997

§ 371 Date: Feb. 15, 2023

(30) Foreign Application Priority Data
Jul. 5, 2019 (CN) 201910605033.1

(51) Int. Cl. A61C 8/00

(52) U.S. Cl. CPC A61C 8/009

(57) ABSTRACT

The present invention relates to a tooth-borne guide plate, a mucosa-borne guide plate, a bone-borne guide plate, and preparation and application methods therefor. The method for preparing a tooth-borne guide plate comprises: a) bonding a radiopaque material to teeth, bonding the radiopaque material to the gingival mucosa or/and bonding the radiopaque material to other anatomical features; b) performing CBCT photography, and acquiring CBCT data with radiopaque material information; c) acquiring oral cavity surface STL data with radiopaque material information; d) matching the CBCT data with the STL data; e) determining the positions of an implant and a retention pin; f) generating a base guide plate; g) generating an in-place guide plate; h) generating an implant guide plate; and i) generating a repair guide plate. By means of the tooth-borne guide plate, the mucosa-borne guide plate, the bone-borne guide plate, and the preparation and application methods therefor provided in the present invention, the precision and success rate of data matching can be improved, thereby improving the patient's comfort, reducing the number of subsequent visits, and reducing clinical medical costs.

### TECHNICAL FIELD

The invention relates to a dental support guide plate, a mucosal support guide plate, a bone support guide plate and preparation and use method thereof, which can be applied to oral implant, orthodontic surgery, repair and so on needs to all kinds of X light, the mark of the CBCT, need or not need to integrate the field of soft and hard tissue data; and applying to oral implant, repairing and so on need pre-operative planning, accurately predicting the case of the surgical result; It is especially suitable for oral implant to implant alveolar ridge top height fully, manufacturing of surgical guide plate with sharp or uneven ridge, belonging to the medical field of oral cavity.

### TECHNICAL BACKGROUND

In the oral cavity field, in order to reach the purpose of precise minimally invasive surgery, the guide plate is used in the planting operation, the manufacturing of the guide plate must be by means of three-dimensional CT or cone-beam scanning CT (CBCT for short). Due to CBCT application limitation, CBCT can only obtain relatively clear jaw bone, tooth body and other hard tissue information (the patent uses CBCT to obtain CBCT data for short), but cannot obtain the soft tissue information with high precision. In general, clinical will use high precision oral surface scanning device for fine scanning oral tissue surface, to obtain the dental tissue and soft tissue information (hereinafter referred to as STL data). Because the CBCT data and STL data contain tooth tissue information, through matching the two data of the tooth tissue information, the CBCT data and STL data can be integrated together, so as to present the bone information of the patient, tooth information and soft tissue information. However, when the oral cavity remaining tooth is not too many, it is difficult to adopt the method, and will adopt more complex method for manufacturing the radiation guide plate to obtain clear soft tissue information and repair information.

In the prior art, when matching the data, if using the oral surface scanning device matching method, the operator manually using software at the same tooth position selecting the corresponding point to match, the method needs to be judged by naked eyes, comprising the following steps:

1. The oral surface scanning device of the oral cavity scanning data information of the patient oral surface scanning device:
2nd, obtaining CBCT data information of patient;
3rd, manually selecting similar position points to match in the software.

The defects of the prior art data matching method are as follows: the matching precision is not high, the operation time is long, even the possibility of matching failure happened. when the oral cavity remaining tooth is not too many, the radiation guide plate method is used for matching; the patient needs to be diagnosed for many times; the radiation guide plate (similar to the product of the movable denture) is prepared in advance; then the shooting of the CBCT is carried out; the patient cost and radiation dose increased in the intangible; and time and workload of the case are increased; so that the whole process is very complex.

In addition, in the oral clinical diagnosis, often encountered loss of tooth, alveolar ridge sharp or uneven patient. At this time, manufacturing the oral implant osteotomy guide plate can help the doctor to accurately trim the alveolar bone ridge according to the CBCT image; then inserting the planting guide plate part; preparing the planting nest hole. In the manufacturing process of the traditional oral implant osteotomy guide plate, the manufacturing process is complicated; the design and manufacturing period is long; the patient most time is in the waiting state; and when the operation needs to repeatedly pick the guide plate, seriously affecting the patient diagnosis experience and high efficiency of the doctor treatment. the traditional method part also adopts manual operation method; the difficulty is large; the threshold is high; suitable for few people; the new oral implant guide plate provided by the invention completely meets the requirement of the surgical guide plate; it not only greatly reduces the difficulty of the doctor for osteotomy, planting and repairing surgery, and diagnosis cost of the patient is also reduced.

In order to improve the planting precision, realizing minimally invasive surgery; in the oral medicine field, more and more doctors want to use surgical guide to guide the planting operation. and wherein, when encountering the need to the jaw bone after re-planting case, using the traditional method for manufacturing operation guide flow is very complex, needing two or more guide plate. When the doctor operates, it needs to wear the osteotomy guide plate firstly, strike the fixing nail, after the osteotomy, take the lower fixing nail and osteotomy guide plate, and then wear the planting guide plate, and again strike the fixing nail. This is a fussy, time-consuming and labor-consuming process. It is a test of physical strength and endurance of the doctor; at the same time, it also provides a severe requirement for the stress tolerance of the patient, and directly reduces the patient's comfort.

In the conventional technology, the doctor generally needs to design a bone-cutting guide plate containing fixing nail sleeve, then repeating the last flow design a planting guide plate, but only the second time to add the implant sleeve and does not carry out virtual osteotomy. After the doctor gets the osteotomy guide plate and planting guide plate, the patient firstly performs the osteotomy, then planting, the two processes will repeatedly take the guide plate and fixing nail. The operation steps are as follows:

1st, scanning the CBCT image and dentition STL surface data for the patient;
2nd, introducing the related data in the oral implant design software; planning the implant position; fixing the position of the nail;
3rd, designing osteotomy guide plate;
4th, designing the planting guide plate;
5th, printing by @3 D;
6. Clinical try-on and surgery.
using the traditional scheme design, the preparation of oral implant surgery guide defect is: In the manufacturing process, the preoperative design, manufacturing work is complicated, many processes need to repeat the same operation; the doctor has a lot of time waste on picking and fixing nail; on the guide plate, the efficiency is low; the patient waiting for the designed period is long and operation time is long.

### Contents of the Invention

The invention claims a tooth supporting guide plate, a mucosa supporting guide plate; The invention claims a bone support type guide plate and preparation and use method thereof, wherein the CBCT data and STL data containing the barrier material information are obtained by adding the barrier material at the corresponding position, and CBCT data and STL data can be accurately matched only by matching the barrier material information in the two; it can greatly improve the matching precision of CBCT data and STL data, improve the comfort of the patient, reduce the diagnosis times, reduce the clinical medical cost, reduce the difficulty of integrating the two data, especially when there are more teeth, it is convenient and easy to manufacture. In addition, the guide plate provided by the invention makes the osteotomy, planting and repairing on a guide plate sleeve can be realized. optimizing the design process, no need to make osteotomy guide plate, planting guide plate, so as to overcome the traditional method needs to repeatedly take the defect of the fixing nail and guide plate, reduces the clinical medical cost and improves the surgical precision, patient diagnosis experience also rises a layer.

In order to solve the above technical problem. The present invention adopts the following solution:

(1) A preparation method of dental support type guide plate, comprising the following steps:
a) the blocking material is adhered on the tooth, the blocking material is adhered on the gingival mucous membrane or/and blocking material is adhered on other anatomical features;
b) carrying out CBCT shooting; obtaining CBCT data with anti-reflection material information;
c) obtaining the oral surface STL data with the anti-reflection material information;
d) matching CBCT data with STL data;
e) determining the implant and retention pin position: according to the CBCT data and STL data matching information, obtaining the pre-tooth position and jaw position, then according to the pre-tooth position and jaw position, determining the implant and position of the fixing nail;
f) generating a substrate guide: determining the position of the fixing nail sleeve and positioning plane according to the implant and fixing nail position; combining the fixing nail sleeve and positioning plane into a whole body; obtaining the substrate guide plate with the fixing nail sleeve;
g) generating a positioning guide plate;
i. generating a positioning guide body portion according to the STL data;
according to the position of the fixing nail sleeve and positioning plane of the substrate guide plate, determining the position of the fixing nail sleeve buckle and tongue side position plane of the positioning guide plate; the fixing nail sleeve buckle of the locating guide plate is matched with the fixing nail sleeve of the substrate guide plate; the tongue side of the locating guide plate is matched with the locating plane of the substrate guide plate;
iii, connecting the positioning guide plate main body part with the fixing nail sleeve buckle and tongue side positioning plane to form a whole body, generating the positioning guide plate;
h) generating a planting guide plate:
i. determining the position of the fixing nail sleeve buckle and tongue side position plane of the planting guide plate according to the position of the fixing nail sleeve and positioning plane of the base guide plate; the fixing nail sleeve buckle of the planting guide plate is matched with the fixing nail sleeve of the substrate guide plate; the tongue side of the planting guide plate is matched with the locating plane of the substrate guide plate;
iith, designing implant sleeve and connecting rod for planting guide plate;
iii. the retaining nail sleeve buckle; the tongue side locating plane; the implant sleeve and connecting rod are connected into a whole to generate the planting guide plate
i) generating a repair guide plate:
i. matching information according to CBCT data and STL data; performing virtual tooth arranging to obtain a prosthesis;
ii. selecting a temporary abutment according to the selected implant, and temporary abutment penetrates the prosthesis;
determining the position of the fixing nail sleeve buckle and tongue side position plane of the repairing guide plate according to the position of the fixing nail sleeve and locating plane of the substrate guide plate; the fixing nail sleeve buckle of the repairing guide plate is matched with the fixing nail sleeve of the substrate guide plate; the tongue side of the repairing guide plate is matched with the locating plane of the substrate guide plate;
iv. designing the connecting rod of the repairing guide plate; connecting the repairing body of the repairing guide plate, the fixing nail sleeve buckle, the tongue side locating plane and connecting rod into a whole body; generating the repairing guide plate.
(2) according to (1) the preparation method of the tooth support type guide plate, further comprising step j): the step f), g), h) and i) generated in the substrate guide plate; the guide plate, planting guide plate and repairing guide output and for 3 D printing.
(3) according to (1) or (2) the preparation method of the tooth support type guide plate, other anatomical features include, mucosa turning, bone protrusion, tongue protrusion.
(4) according to (1)-(3) any one of the dental support type guide plate preparation method, on the tooth, on the gingival mucous membrane or/and other anatomical features at least 4 point adhesive resistance material.
(5) according to (1)-(4) any one of the tooth support type guide plate preparation method, wherein the method for obtaining the oral surface STL data with the impedance material information comprises:
a) taking the oral impression; the blocking material will leave the mark on the corresponding position of the impression material; after the mould is hard to be printed, the blocking material is reset to the impression; using the oral surface scanning device to scan the oral cavity impression; namely, obtaining STL data with the blocking material information;
b) or using oral surface scanning device to directly scan in the oral cavity; obtaining STL data with anti-reflection material information;
c) or bonding the barrier material at the thickest and thinnest part of the oral mucosa, then displaying the bone in the CBCT data according to CBCT; tooth information and suspended resistance material information; because the suspension of the impedance material is adhered on the soft tissue, by analyzing the impedance material and bone relation, it can analyze the relationship and thickness of the bone and mucosa, so as to obtain soft tissue information, finally obtaining STL data.
(6) according to (1)-(5) any one of the dental support-type guide plate preparation method, the CBCT data and STL data matching comprises: integrating the CBCT data and STL data, taking the information of the blocking material as the matching basis, by adjusting the tooth tissue information in the CBCT data and STL data, finally matching the jaw bone information, tooth tissue information, soft tissue information.
(7) according to (1)-(6) any one of the dental support-type guide plate preparation method, the prosthesis is repairing dentition.
(8) A tooth support type guide plate prepared by the preparation method of the tooth support type guide plate according to any one of the (1)-(7), comprising a substrate guide plate, a planting guide plate, a repairing guide plate and a positioning guide plate;
a fixing nail sleeve and a locating plane are arranged on the substrate guide plate;
the planting guide plate is provided with an implant sleeve, a fixing nail sleeve buckle and a tongue side locating plane; the fixing nail sleeve is buckled on the fixing nail sleeve so that the planting guide plate is connected with the substrate guide plate; the tongue side locating plane of the planting guide plate is matched with the locating plane of the substrate guide plate;
a fixing nail sleeve buckle and a tongue side locating plane are arranged on the repairing guide plate; the fixing nail sleeve is buckled on the fixing nail sleeve so that the repairing guide plate is connected with the substrate guide plate; the tongue side locating plane of the repairing guide plate is matched with the locating plane of the substrate guide plate;
the locating guide plate is provided with a fixing nail sleeve buckle and a tongue side locating plane; the tongue side locating plane is matched with the locating plane of the substrate guide plate; the fixing nail sleeve is buckled on the fixing nail sleeve so that the positioning guide plate is connected with the substrate guide plate.
(9) according to (8) the tooth supporting guide plate; the planting guide plate, repairing guide plate and guide plate are respectively provided with a connecting rod; the connecting rod is connected with the fixing nail sleeve buckle.
(10) according to (9) the tooth supporting guide plate; the repairing guide plate is provided with a repairing body; the repairing body is connected with the tongue side locating plane and fixing nail sleeve buckle; when the repairing body is finally planted, grinding the tongue side locating plane, fixing nail sleeve buckle and connecting rod.
(11) according to (10) or (11) the tooth supporting guide plate, further comprising an implant, implanting implant through implant sleeve, on the implant is connected with a temporary base; the temporary base is bonded with the repairing body on the repairing guide plate.
(12) A method for using the dental support guide plate according to any one of the (8)-(11);
a) connecting the positioning guide plate and base guide plate together; wearing the patient opening; after confirming the positioning, punching the fixing nail according to the fixing nail sleeve; taking off the positioning guide plate;
b) removing the redundant teeth;
c) subsequently wearing the planting guide plate according to the outer surface of the fixing nail sleeve of the substrate guide plate and positioning plane, and matching the positioning plane of the substrate guide plate with the tongue side positioning plane of the planting guide plate; after wearing the planting guide plate, implanting the implant through the implant sleeve;
d) after implanting the implant, taking off the planting guide plate; then installing temporary abutment on the implant, and wearing repairing guide plate according to the outer surface of the fixing nail sleeve of the substrate guide plate and positioning plane; matching the positioning plane of the substrate guide plate with the tongue side positioning plane of the repairing guide plate; after wearing the repairing guide plate, placing the bonding material around the temporary base station to bond the temporary base station and repairing guide plate together;
e) after bonding, taking off the temporary base and repairing guide plate, grinding the connecting rod on the repairing guide plate, tongue side locating plane and fixing nail sleeve buckle, leaving the repairing body, and grinding the temporary base protruding out of the repairing guide plate;
f) taking off the substrate guide plate; wearing the prosthesis in the step e); fixing the temporary abutment and implant.
(13) a preparation method of mucosal support type guide plate, wherein
a) the blocking material is adhered on the oral mucosa, the blocking material is adhered on the dental arch mucous membrane or/and blocking material is adhered on the dental embankment;
b) carrying out CBCT shooting; obtaining CBCT data with anti-reflection material information;
c) obtaining the oral surface STL data with the anti-reflection material information;
d) matching CBCT data with STL data;
e) determining the implant and retention pin position: according to the CBCT data and STL data matching information, obtaining the pre-tooth position and jaw position, then according to the pre-tooth position and jaw position, determining the implant and position of the fixing nail;
f) generating a substrate guide: determining the position of the fixing nail sleeve and positioning plane according to the implant and fixing nail position; combining the fixing nail sleeve and positioning plane into a whole body; obtaining the substrate guide plate with the fixing nail sleeve;
g) generating a planting guide plate:
i. determining the position of the fixing nail sleeve buckle and tongue side position plane of the planting guide plate according to the position of the fixing nail sleeve and positioning plane of the base guide plate; the fixing nail sleeve buckle of the planting guide plate is matched with the fixing nail sleeve of the substrate guide plate; the tongue side of the planting guide plate is matched with the locating plane of the substrate guide plate;
iith, designing implant sleeve and connecting rod for planting guide plate;
iii, the fixing nail sleeve buckle, tongue side locating plane; the implant sleeve and connecting rod are connected as a whole, generating planting guide plate;
h) generating a repair guide plate:
i. matching information according to CBCT data and STL data; performing virtual tooth arranging to obtain a prosthesis;
ii. selecting a temporary abutment according to the selected implant, and temporary abutment penetrates the prosthesis;
determining the position of the fixing nail sleeve buckle and tongue side position plane of the repairing guide plate according to the position of the fixing nail sleeve and locating plane of the substrate guide plate; the fixing nail sleeve buckle of the repairing guide plate is matched with the fixing nail sleeve of the substrate guide plate; the tongue side of the repairing guide plate is matched with the locating plane of the substrate guide plate;
iv. designing the connecting rod of the repairing guide plate; connecting the repairing body of the repairing guide plate, the fixing nail sleeve buckle, the tongue side locating plane and connecting rod into a whole body; generating the repairing guide plate.
(14) according to (13) the preparation method of the mucosa supporting guide plate, further comprising step j): the step i), g) and h) generating the substrate guide plate, planting guide plate and repairing guide output and performing the 3 D printing
(15) The preparation method of the mucosal support type guide plate according to (13) or (14), on the oral mucosa, at least 4 point adhesive resistance material on the dental arch mucosa or/and on the dental dyke.
(16) according to (13)-(15) any one of the mucosal support type guide plate preparation method, the method for obtaining oral surface STL data with anti-reflection material information comprises:
a) taking the oral cavity impression; the blocking material will leave the mark on the corresponding position of the impression material; after the mould is hard to be printed, copying the blocking material to the impression; using the oral surface scanning device to scan the oral impression; obtaining the STL data with the information of the blocking material;
b) or using oral surface scanning device to directly scan in the oral cavity; obtaining STL data with anti-reflection material information;
c) or bonding the barrier material at the thickest and thinnest part of the oral mucosa; then according to CBCT, the CBCT data displays the bone and suspended barrier material information; because the suspended barrier material is adhered on the soft tissue, by analyzing the barrier material and bone relation, the relation and thickness of the bone and mucosa can be analyzed; so as to obtain soft tissue information, finally obtaining STL data.
(17) according to (13)-(16) any one of the mucosal support type guide plate preparation method, the CBCT data and STL data matching comprises: integrating the CBCT data and STL data, taking the information of the blocking material as the matching basis, by adjusting the tissue information in the CBCT data and STL data, finally matching the jaw bone information and soft tissue information.
(18) according to (13)-(17) any one of the mucosal support type guide plate preparation method, the prosthesis is repair dentition.
(19) A mucous membrane supporting guide plate prepared by the preparation method of the mucosa supporting guide plate according to any one of the (13)-(18), comprising a substrate guide plate, a planting guide plate and a repairing guide plate;
a fixing nail sleeve and a locating plane are arranged on the substrate guide plate;
the planting guide plate is provided with an implant sleeve, a fixing nail sleeve buckle and a tongue side locating plane; the fixing nail sleeve is buckled on the fixing nail sleeve so that the planting guide plate is connected with the substrate guide plate; the tongue side locating plane of the planting guide plate is matched with the locating plane of the substrate guide plate;
a fixing nail sleeve buckle and a tongue side locating plane are arranged on the repairing guide plate; the fixing nail sleeve is buckled on the fixing nail sleeve so that the repairing guide plate is connected with the substrate guide plate; the tongue side locating plane of the repairing guide plate is matched with the locating plane of the substrate guide plate.
(20) the mucosa supporting guide plate according to (19); the planting guide plate and repairing guide plate are respectively provided with a connecting rod; the connecting rod is connected with the fixing nail sleeve buckle.
(21) according to (19) or (20) the mucosa supporting guide plate; the repairing guide plate is provided with a repairing body; the repairing body is connected with the tongue side locating plane and fixing nail sleeve buckle; when the repairing body is finally planted, grinding the tongue side locating plane, fixing nail sleeve buckle and connecting rod.
(22) according to (19)-(21) any one of the mucosal support-type guide plate, further comprising an implant, implanting implant through implant sleeve, the implant is connected with a temporary base; the temporary base is bonded with the repairing body on the repairing guide plate.
(23) a method of using the mucosal support type guide plate according to any one of the (18)-(22);
a) the substrate guide is worn in the patient mouth, after confirming the position according to the fixing nail sleeve fixing nail;
b) subsequently wearing the planting guide plate according to the outer surface of the fixing nail sleeve of the substrate guide plate and positioning plane, and matching the positioning plane of the substrate guide plate with the tongue side positioning plane of the planting guide plate; after wearing the planting guide plate, implanting the implant through the implant sleeve;
c) after implanting the implant, taking off the planting guide plate; then installing temporary abutment on the implant, and wearing repairing guide plate according to the outer surface of the fixing nail sleeve of the substrate guide plate and positioning plane; matching the positioning plane of the substrate guide plate with the tongue side positioning plane of the repairing guide plate; after wearing the repairing guide plate, placing the bonding material around the temporary base station to bond the temporary base station and repairing guide plate together;
d) after bonding, taking off the temporary base and repairing guide plate; grinding the connecting rod on the repairing guide plate; the tongue side locating plane and fixing nail sleeve buckle; leaving the repairing body; and grinding the temporary base protruding out of the repairing guide plate;
e) taking off the substrate guide plate; wearing the prosthesis in the step d); fixing the temporary abutment and implant.
(24) a preparation method of bone supporting guide plate, comprising the following steps:
a) shooting CBCT to the jaw bone to obtain CBCT data;
b) determining the position of the implant and retention pin: obtaining the pre-tooth position and jaw position according to the obtained CBCT data; then according to the pre-tooth position and jaw position, determining the implant and position of the fixing nail;
c) generating a substrate guide plate; determining the position of the fixing nail sleeve and positioning plane according to the implant and fixing nail position; combining the fixing nail sleeve and positioning plane into a whole body; obtaining the substrate guide plate with the fixing nail sleeve;
d) generating a planting guide plate:
i. determining the position of the fixing nail sleeve buckle and tongue side position plane of the planting guide plate according to the position of the fixing nail sleeve and positioning plane of the base guide plate; the fixing nail sleeve buckle of the planting guide plate is matched with the fixing nail sleeve of the substrate guide plate; the tongue side of the planting guide plate is matched with the locating plane of the substrate guide plate;
iith, designing implant sleeve and connecting rod for planting guide plate;
iii, the fixing nail sleeve buckle, tongue side locating plane; the implant sleeve and connecting rod are connected as a whole, generating planting guide plate;
e) generating a repair guide plate:
i. matching information according to CBCT data and STL data; performing virtual tooth arranging to obtain a prosthesis;
ii. selecting a temporary abutment according to the selected implant, and temporary abutment penetrates the prosthesis;
determining the position of the fixing nail sleeve buckle and tongue side position plane of the repairing guide plate according to the position of the fixing nail sleeve and locating plane of the substrate guide plate; the fixing nail sleeve buckle of the repairing guide plate is matched with the fixing nail sleeve of the substrate guide plate; the tongue side of the repairing guide plate is matched with the locating plane of the substrate guide plate; designing the connecting rod of the repairing guide plate; the repairing body of the repairing guide plate, fixing nail sleeve buckle; the tongue side locating plane and connecting rod are connected as a whole, generating repairing guide plate.
(25) The preparation method of the bone support type guide plate according to (24), further comprising step f): the step c), d) and e) generated in the substrate guide plate, planting guide plate and repairing guide output and for 3 D printing.
(26) according to (23) or (24) the bone support type guide plate preparation method, the prosthesis is repair dentition.
(27) one kind of (24)-(26) any one of the bone support type guide plate prepared by the preparation method of bone-supporting guide plate, comprising a substrate guide plate, planting guide plate and repairing guide plate;
a fixing nail sleeve and a locating plane are arranged on the substrate guide plate;
the planting guide plate is provided with an implant sleeve, a fixing nail sleeve buckle and a tongue side locating plane; the fixing nail sleeve is buckled on the fixing nail sleeve so that the planting guide plate is connected with the substrate guide plate; the tongue side locating plane of the planting guide plate is matched with the locating plane of the substrate guide plate;
a fixing nail sleeve buckle and a tongue side locating plane are arranged on the repairing guide plate; the fixing nail sleeve is buckled on the fixing nail sleeve so that the repairing guide plate is connected with the substrate guide plate; the tongue side locating plane of the repairing guide plate is matched with the locating plane of the substrate guide plate.
(28) according to (27) the bone supporting guide plate; the planting guide plate and repairing guide plate are respectively provided with a connecting rod; the connecting rod is connected with the fixing nail sleeve buckle.
(29) according to (27) or (28) the bone supporting guide plate; the repairing guide plate is provided with a repairing body; the repairing body is connected with the tongue side locating plane and fixing nail sleeve buckle; when the repairing body is finally planted, grinding the tongue side locating plane, fixing nail sleeve buckle and connecting rod.
(30) according to (27)-(29) any one of the bone support guide plate, further comprising an implant, implant through implant, the implant is connected with a temporary base; the temporary base is bonded with the repairing body on the repairing guide plate.
(31) one of the (27)-(30) any one of the bone support type guide plate using method, wherein
a) turning the flap in the patient mouth, then wearing the substrate guide plate, confirming the position according to the fixing nail sleeve fixing nail, then reference position plane to the jaw bone operation;
b) subsequently wearing the planting guide plate according to the outer surface of the fixing nail sleeve of the substrate guide plate and positioning plane, and matching the positioning plane of the substrate guide plate with the tongue side positioning plane of the planting guide plate; after wearing the planting guide plate, implanting the implant through the implant sleeve;
c) after implanting the implant, taking off the planting guide plate; then installing temporary abutment on the implant, and wearing repairing guide plate according to the outer surface of the fixing nail sleeve of the substrate guide plate and positioning plane; matching the positioning plane of the substrate guide plate with the tongue side positioning plane of the repairing guide plate; after wearing the repairing guide plate, placing the bonding material around the temporary base station to bond the temporary base station and repairing guide plate together;
d) after bonding, taking off the temporary base and repairing guide plate; grinding the connecting rod on the repairing guide plate; the tongue side locating plane and fixing nail sleeve buckle; leaving the repairing body; and grinding the temporary base protruding out of the repairing guide plate;
e) taking off the substrate guide plate, suturing the patient mucosa, wearing the prosthesis in the step d), fixing the temporary abutment and implant.

The invention claims a guide plate and preparation and application method thereof, the beneficial technical effects are as follows:

1; Because of the occurrence of the barrier material, without manual selection of the matching point, which can greatly improve the CBCT data and STL data matching precision and success rate, when the oral cavity remaining tooth is not large, there is no need to make radiation guide plate, which can greatly improve the comfort of the patient, reduce the diagnosis times, reduce clinical medical cost; It reduces the difficulty of integrating CBCT data and STL data.
2nd, because it does not need to manufacture radiation guide plate, directly using CBCT, scanner or other technology to directly scan the data of the oral surface and bone, improving denture manufacturing, surgical guide precision.
3rd, the invention does not need respectively manufacturing osteotomy guide plate, planting guide plate, can shorten greatly shortens the manufacturing period, simplifies the doctor clinical operation procedure, reduces the patient waiting time, reduces the clinical medical cost, greatly improves the patient diagnosis experience.
4th, according to the bone plane height, width information provided by the guide plate; implant implanting orientation information and repairing the occlusion information of dentists; the doctor can refer to osteotomy plane indicated by osteotomy substrate guide plate for osteotomy during surgery, referring to the depth indicated by the planting guide plate; axial and so on; Pick-up is carried out according to the occlusion information provided by the repairing guide plate, finally finishing planting and repairing; compared with the traditional manual operation, it not only saves time, saves trouble, saves labour, but also greatly improves the surgical precision.

The meanings of the related terms in the present invention are as follows:

1. CBCT Cone Beam Computing Tomography): is a cone-beam projector computer recombination fault image device for obtaining oral three-dimensional image data information.
2. CBCT data refers to the jaw bone obtained by CBCT, tooth body and other related information.
(3. STL Triangulation Language): for representing a file format of the triangular grid. Its file format is very simple, and it is widely used.
4. STL data refers to the information related to the dental tissue, soft tissue and so on the oral cavity. it can use high precision oral surface scanning device to perform fine scanning of oral tissue surface, obtaining STL data containing dental tissue, soft tissue and other related information.
5. Radiation Guide (Scan Appliance Guide): The invention claims a resin auxiliary device similar to movable denture, realizing simultaneous development of tooth-arranging information in CBCT.
6. The Bone Reduction Guide (Bone Reduction Guide): a guide plate for cutting the sharp or uneven part of the crest of the alveolar ridge; then inserting the planting guide plate part; preparing the planting pit;

The threshold value is: also called critical value, generalized refers to a lowest value or the highest value generated by the effect. in the application of oral planting, by adjusting the highest threshold and lowest threshold of CBCT image threshold to satisfy the implant virtual implant timing for the requirement of jaw bone density.

(8. DICOM Imaging and Communications in Medicine): Medical digital image transmission protocol is a group of universal standard protocol, for medical image processing, storage, printing and transmission. It contains definition of file format and network communication protocol, based on TCP/IP, and contacts each system by TCP/IP, and can integrate medical image instrument of different manufacturers, server, work station, printer and network device.
9. Stack@fixing nail: The invention is mainly used for oral non-tooth maxillofacial implant operation, so as to avoid the guide plate shift caused by the transmutability of the mucosa.

The following are the following: divided into a fixing nail sleeve and an implant sleeve, for guiding the clinician to accurately implant the retention nail or implant according to the designed position of the retention nail or implant.

11. Metal Guide Ring: embedded in the sleeve to assist stable drilling; at the same time, avoiding the high speed rotating drilling needle directly contacting the resin sleeve, damaging the original structure.

### DESCRIPTION OF PICTURES

The present invention will be further described in detail with reference to the accompanying drawings and specific embodiments.

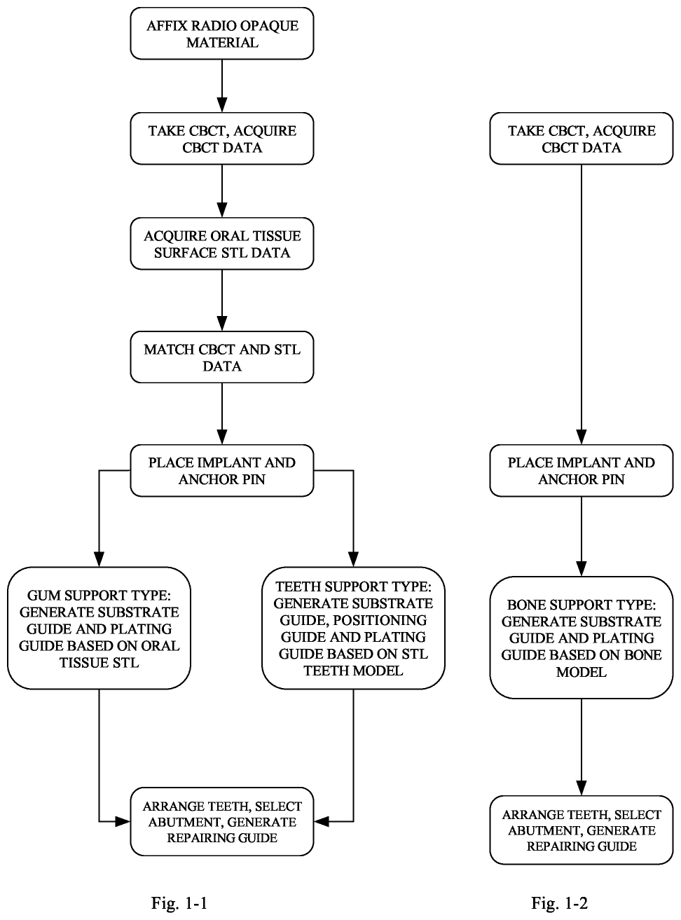

FIG. 1-1 is a tooth support type guide plate and mucosal support type guide preparation method of flow diagram;

FIG. 1-2 is a bone support type guide preparation method of flow diagram;

FIG. 2 is a schematic view of a circular single blocking point;

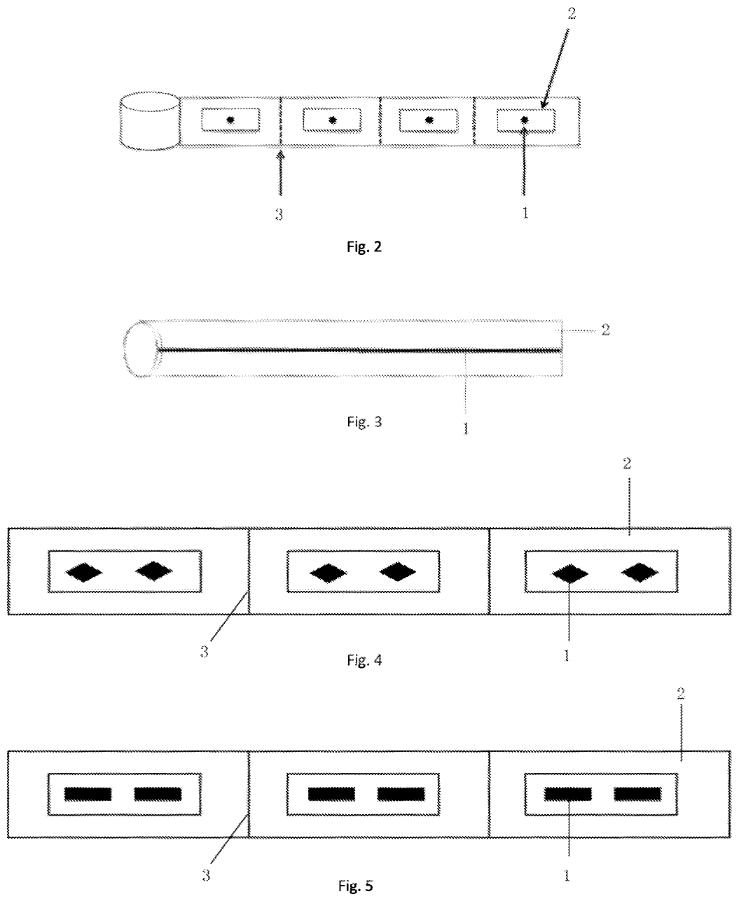

FIG. 3 is a schematic view of a linear impedance material;

FIG. 4 is a schematic view of a diamond-shaped blocking point;

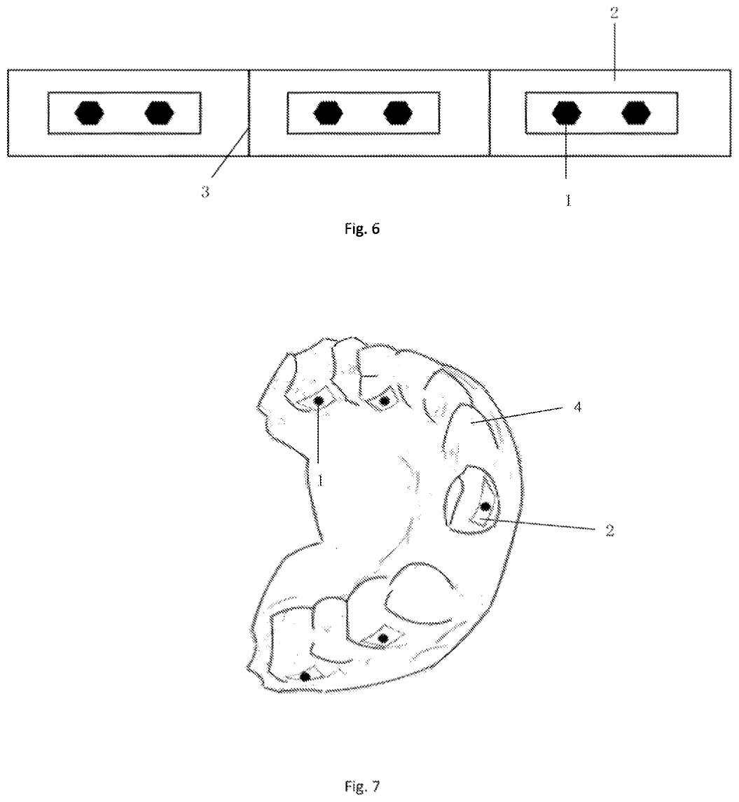

FIG. 5 is a schematic view of a rectangular blocking point;

FIG. 6 is a schematic view of a polygonal blocking point;

FIG. 7 is a schematic view of the adhesive blocking point on the tooth;

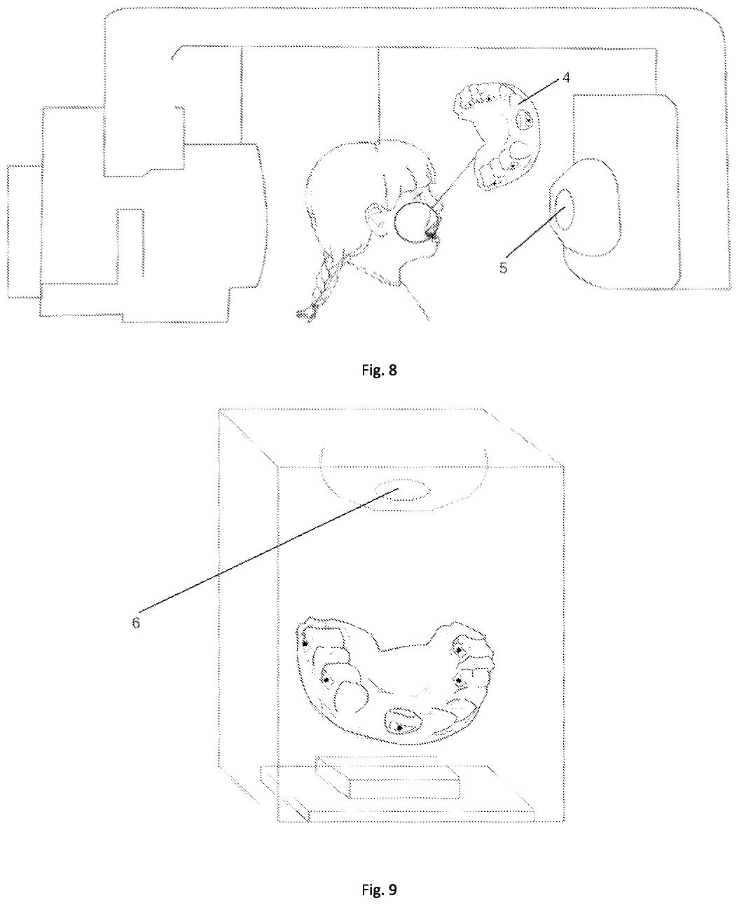

FIG. 8 is a schematic diagram of photographing CBCT after adhering a stop point on the tooth;

FIG. 9 is a schematic diagram of obtaining the patient model STL data using a surface scanning device;

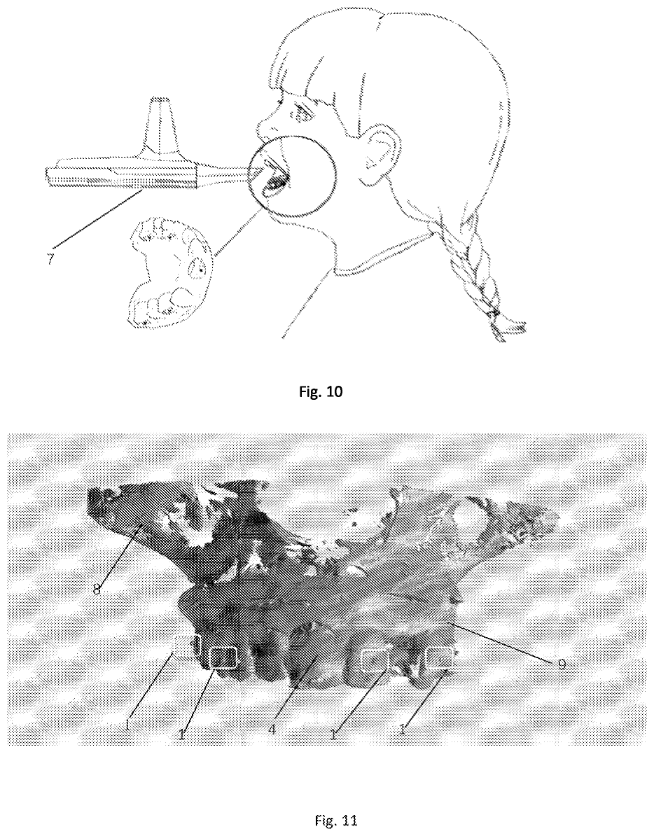

FIG. 10 is a schematic diagram of acquiring STL data directly in the patient's mouth by using a surface scanning device;

FIG. 11 is a schematic diagram illustrating the matching of CBCT data and STL data by using a blocking point in software;

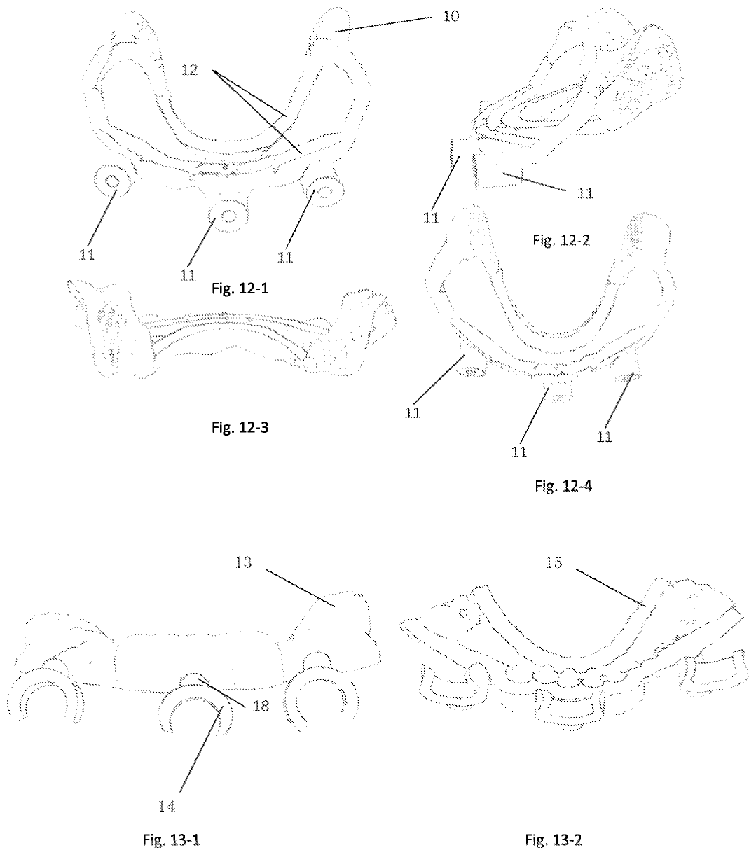

FIG. 12-1 is a main view of the substrate guide;

FIG. 12-2 is a right view of the substrate guide plate;

FIG. 12-3 is a rear view of the substrate guide;

FIG. 12-4 is a top view of the substrate guide;

FIG. 13-1 is the structure schematic diagram of the guide plate;

FIG. 13-2 is a bottom view of FIG. 13-1;

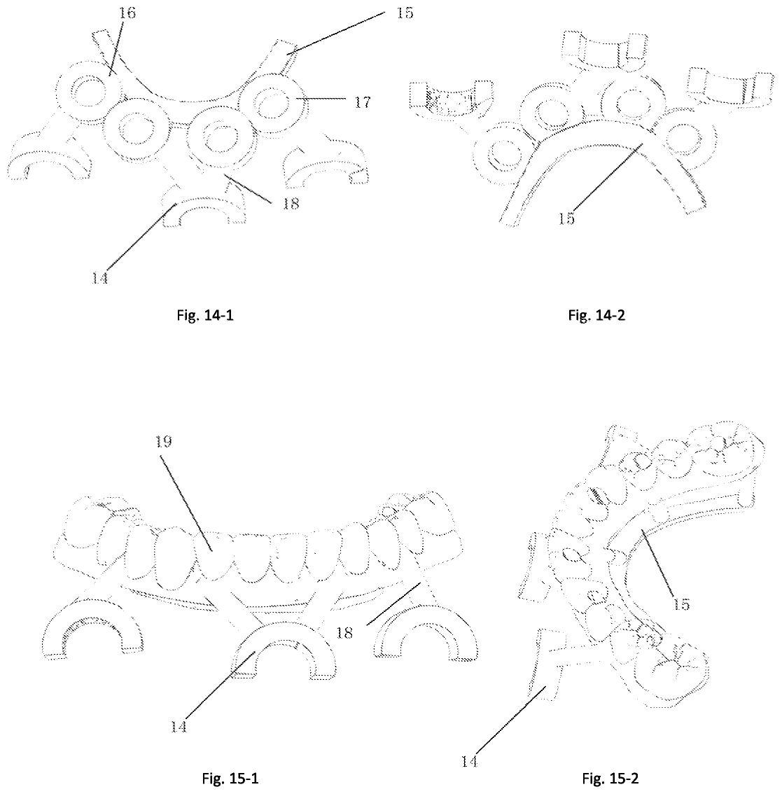

FIG. 14-1 is a structure schematic diagram of the planting guide plate;

FIG. 14-2 is a bottom view of FIG. 14-1;

FIG. 15-1 is a structure schematic diagram of repairing guide plate;

FIG. 15-2 is a three-dimensional graph of repairing guide plate;

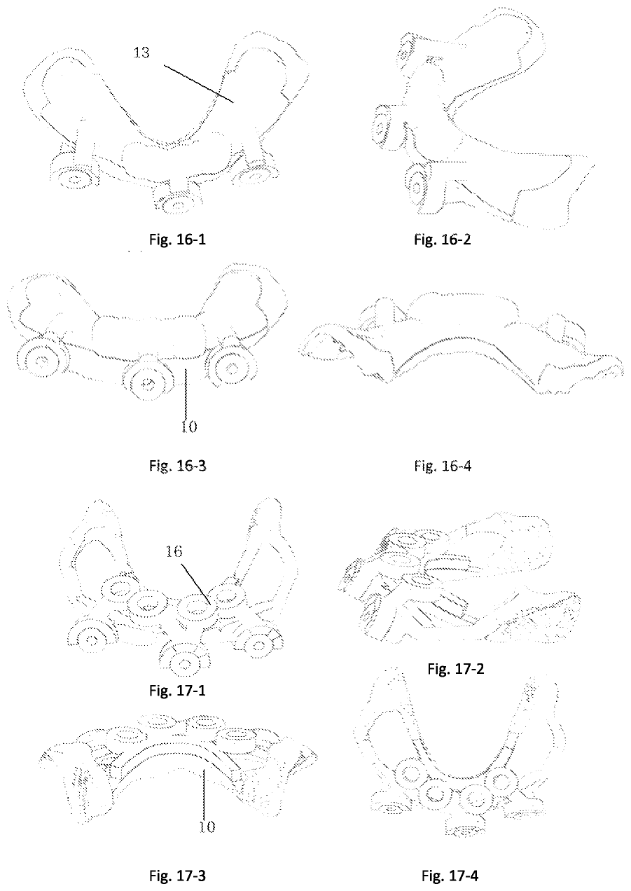

FIG. 16-1 is a positioning guide plate matched with the main view of the substrate guide plate;

FIG. 16-2 is a right view of the positioning guide plate matched with the substrate guide plate;

FIG. 16-3 is a front view of the positioning guide plate matched with the substrate guide plate;

FIG. 16-4 is a rear view of the positioning guide plate matched with the substrate guide plate;

FIG. 17-1 is a planting guide plate matched with the main view of the substrate guide plate;

FIG. 17-2 is a planting guide plate matched with the right view of the substrate guide plate;

FIG. 17-3 is a planting guide plate matched with the rear view of the substrate guide;

FIG. 17-4 is a planting guide plate matched with the top view of the substrate guide;

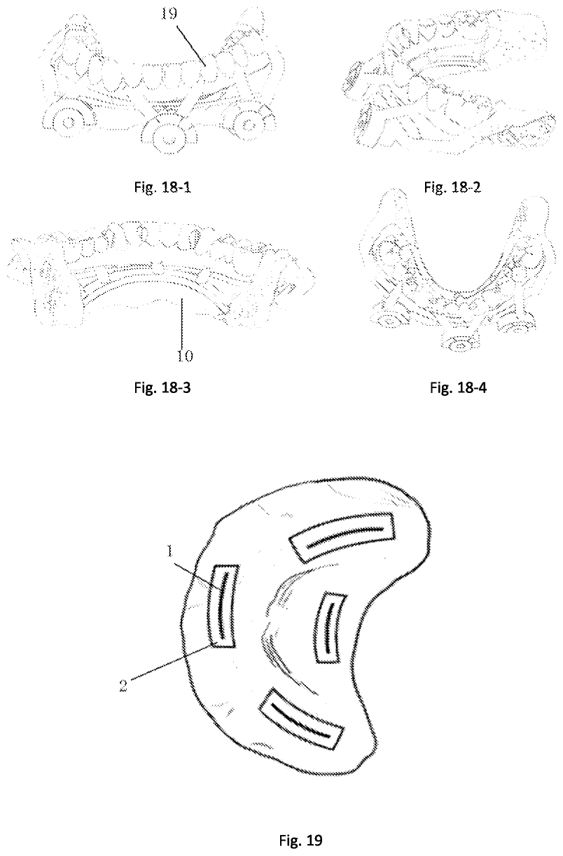

FIG. 18-1 is a repair guide matched with the main view of the substrate guide plate;

FIG. 18-2 is a repairing guide plate matched with the right view of the substrate guide plate;

FIG. 18-3 is a repair guide matched with the rear view of the substrate guide plate;

FIG. 18-4 is a view of the repairing guide plate matched with the substrate guide plate;

FIG. 19 is a schematic diagram of adhering a stop strip on soft tissue;

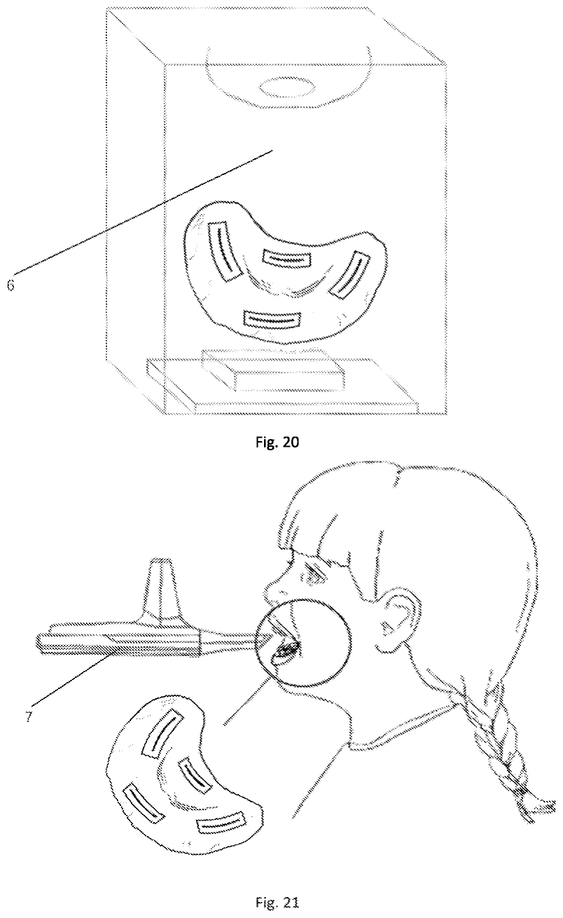

FIG. 20 is a schematic diagram of obtaining the patient model STL data using a surface scanning device;

FIG. 21 is a schematic diagram of acquiring STL data directly in the patient's mouth by using a surface scanning device;

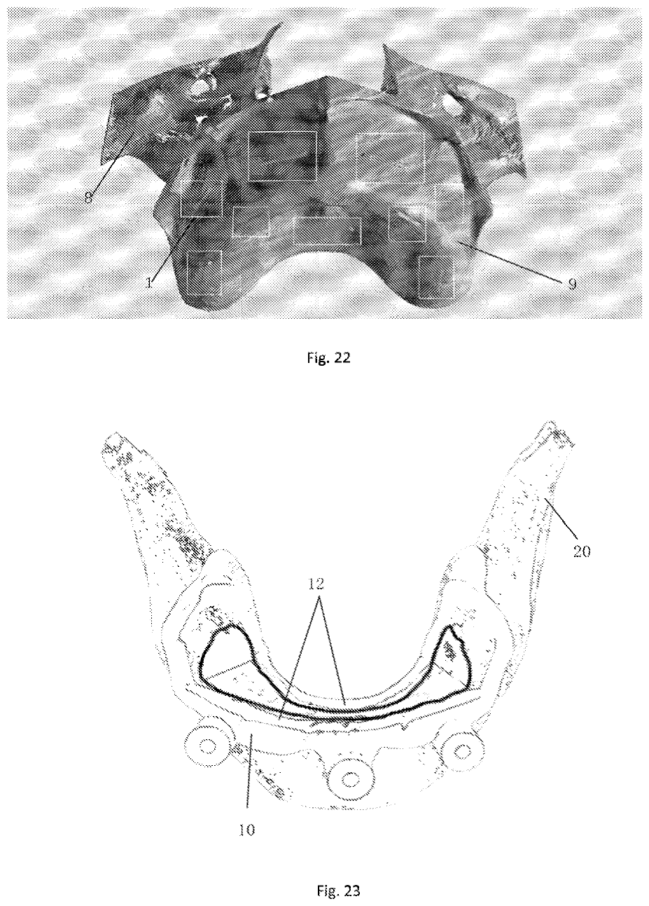

FIG. 22 is a schematic diagram of matching CBCT data with STL data without teeth in software by using a blocking point;

FIG. 23 is a schematic diagram of osteotomy after wearing the osteotomy guide plate;

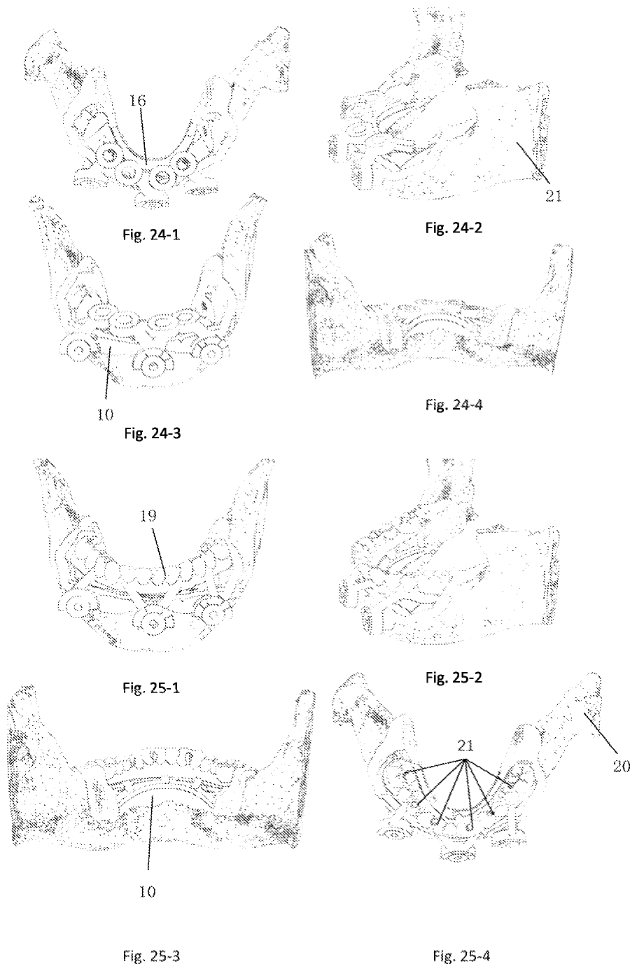

FIG. 24-1 is the main view of the osteotomy guide plate after osteotomy;

FIG. 24-2 is a bone after the planting guide plate matched with the right view of the osteotomy guide plate;

FIG. 24-3 after the osteotomy guide plate matched with the front view of the osteotomy guide plate;

FIG. 24-4 after the osteotomy guide plate matched with the rear view of the osteotomy guide plate;

FIG. 25-1 is a repair guide located on the main view of the osteotomy guide plate;

FIG. 25-2 is a repair guide plate located on the right view of the osteotomy guide plate;

FIG. 25-3 is a repair guide located on the rear view of the osteotomy guide plate;

FIG. 25-4 is a view of the osteotomy guide plate repairing guide plate.

In the picture: 1 is a barrier material; 2 is mark rubberized fabric; 3 is cutting line; 4 is tooth; 5 is CBCT, 6 is oral surface scanning device; 7 is another oral surface scanning device; 8 is jaw bone; 9 is soft tissue; 10 is substrate guide plate; 11 is fixing nail sleeve; 12 is locating plane; 13 is the guide plate; 14 is fixing nail sleeve buckle; 15 is tongue side locating plane; 16 is planting guide plate; 17 is implant sleeve; 18 is connecting rod; 19 is repairing guide plate; 20 is jaw bone; 21 is temporary base.

### SPECIFIC IMPLEMENTATION EXAMPLES

### Example 1

As shown in FIGS. 2 to 6, a barrier material, the shape of the barrier material 1 is point (as shown in FIG. 2), line (as shown in FIG. 3) or stripe, and is set on the mark adhesive tape 2. the spot-shaped blocking material is circular (as shown in FIG. 2), rhombus (as shown in FIG. 4), rectangular (as shown in FIG. 5) or polygon (as shown in FIG. 6). The point-shaped blocking material is a single point (as shown in FIG. 2), two points (as shown in FIG. 4-6) or a combination of multiple points. the mark adhesive tape is provided with a cutting line 3 (as shown in FIG. 2nd, 4, 5, 6). The packaging requirement and production strategy are different; the blocking material can be roll-shaped packaging, single-sheet packaging or multi-sheet packaging.

### Example 2

As shown in FIG. 1-1, a preparation method of tooth supporting guide plate, comprising the following steps:

a) the blocking material 1 is adhered on the tooth 4 (as shown in FIG. 7), the blocking material is adhered on the gingival mucous membrane or/and blocking material is adhered on other anatomical features; on the tooth, at least 4 point bonding resistance material on the gum mucous membrane or/and other anatomical features; Other anatomical features include, mucosal turning, bone protrusion, tongue protrusion;
b) carrying out CBCT shooting; obtaining CBCT data with the blocking material information (as shown in FIG. 8);
c) obtaining the oral surface STL data with impedance material information, the method comprising:
i. taking the oral impression; the blocking material will leave the mark on the corresponding position of the impression material; after the impression material is hard, the blocking material is reset to the impression; using the oral surface scanning device 6 to scan the oral impression; namely, obtaining STL data with the blocking material information (as shown in FIG. 9);
ii. or using an oral surface scanning device 7 to scan directly within the oral cavity, obtaining STL data with the information of the blocking material (as shown in FIG. 9);
iii. bonding a barrier material at the thickest and thinnest part of the oral mucosa, and then displaying the bone in the CBCT data at this time, according to CBCT; tooth information and suspended resistance material information; because the suspension of the impedance material is adhered on the soft tissue, by analyzing the impedance material and bone relation, it can analyze the relationship and thickness of the bone and mucosa, so as to obtain soft tissue information, finally obtaining STL data.
d) matching the CBCT data with the STL data: integrating the CBCT data and STL data, taking the information of the blocking material as the matching basis, by adjusting the tooth tissue information in the CBCT data and STL data, finally making the jaw bone 8 information, tooth body 4 tissue information, soft tissue 9 information matching (as shown in FIG. 11).
e) determining the implant and retention pin position: according to the CBCT data and STL data matching information, obtaining the pre-tooth position and jaw position, then according to the pre-tooth position and jaw position, determining the implant and position of the fixing nail;
f) generating a substrate guide plate 10: according to the implant and fixing nail position, determining the position of the fixing nail sleeve 11 and position plane 12, the fixing nail sleeve 11 and positioning plane 12 are combined into a whole, obtaining the fixing nail sleeve 11 of the substrate guide 10 (as shown in FIGS. 12-1 to 12-4);
g) generating the positioning guide plate 13:
i. generating a positioning guide body portion according to the STL data;
according to the position of the retention pin sleeve 11 and positioning plane 12 of the base guide plate 10, determining the position of the retention pin sleeve buckle 14 and tongue side positioning plane 15 of the positioning guide plate 13; the fixing nail sleeve buckle 14 of the positioning guide plate 13 is matched with the fixing nail sleeve 11 of the base guide plate 10; the tongue side positioning plane 15 of the positioning guide plate 13 is matched with the positioning plane 12 of the base guide plate 10;
iii. connecting the positioning guide body portion with the retention pin sleeve buckle 14 and tongue side in-position plane 15 to form an integral body, generating the positioning guide plate 13 (as shown in 13-2 13-1
h) generating the planting guide plate 16:
i. determining the position of the retention pin sleeve buckle 14 and tongue side positioning plane 15 of the planting guide plate 16 according to the position of the retention pin sleeve 11 and positioning plane 12 of the base guide plate 10; the fixing nail sleeve buckle 14 of the planting guide plate 16 is matched with the fixing nail sleeve 11 of the substrate guide plate 10; the tongue side of the planting guide plate 16 is matched with the locating plane 12 of the substrate guide plate 10;
ii. designing the implant sleeve 17 and connecting rod 18 of the planting guide plate 16;
iii. the retention pin sleeve 14, the tongue side in position plane 15, the implant sleeve 17 and connecting rod 18 are integrally connected to form a planting guide 16 (as shown in FIGS. 14-1 to 14-2);
i) generating repair guide plate 19:
i. matching information according to CBCT data and STL data; performing virtual tooth arranging to obtain a prosthesis;
ii. The temporary abutment 21 is selected according to the selected implant, and temporary abutment 21 passes through the prosthesis;
iii. determining the position of the retention pin sleeve buckle 14 and tongue side in-position plane 15 of the repair guide plate 19 according to the position of the retention pin sleeve 11 and positioning plane 12 of the base guide plate 10; the fixing nail sleeve buckle 14 of the repairing guide plate 19 is matched with the fixing nail sleeve 11 of the substrate guide plate 10; the tongue side of the repairing guide plate 19 is matched with the locating plane 12 of the substrate guide plate 10;
iv. designing the connecting rod 18 of the repairing guide plate 19; connecting the repairing body of the repairing guide plate, the fixing nail sleeve buckle 14, the tongue side locating plane 15 and connecting rod 18 as a whole; generating the repairing guide plate 19 (as shown in FIGS. 15-1 to 15-2).
further comprising step j): the step f), g), h) and i) generated in the substrate guide plate 10; the guide plate 13, planting guide plate 16 and repairing guide plate 19 output and for 3 D printing.

Preferably, the prosthesis is repairing dentition.

### Example 3

As shown in FIGS. 12-1 to 12-4, FIGS. 14-1 14-1 to 13-2 14-2, FIGS. 15-1 to 15-2, FIGS. 15-1 to 15-2 shown in FIG. 15-1 according to embodiment 2 of the tooth support type guide plate prepared by the preparation method of the tooth support type guide plate; comprising a substrate guide plate 10, planting guide plate 16, repairing guide plate 19 and guide plate 13;

a fixing nail sleeve 11 and a locating plane 12 are arranged on the substrate guide plate 10;
the planting guide plate 16 is provided with an implant sleeve 17, a fixing nail sleeve buckle 14 and a tongue side locating plane 15; the fixing nail sleeve buckle 14 is buckled on the fixing nail sleeve 11 so that the planting guide plate 16 is connected with the substrate guide plate 10; the tongue side positioning plane 15 of the planting guide plate 16 is matched with the positioning plane 12 of the substrate guide plate 10;
the repairing guide plate 19 is provided with a fixing nail sleeve buckle 14 and a tongue side locating plane 15; the fixing nail sleeve buckle 14 is buckled on the fixing nail sleeve 11 so that the repairing guide plate 19 is connected with the substrate guide plate 10; the tongue side positioning plane 15 of the repairing guide plate 19 is matched with the positioning plane 12 of the substrate guide plate 10;
the positioning guide plate 13 is provided with a fixing nail sleeve buckle 14 and a tongue side locating plane 15; the tongue side positioning plane 15 is matched with the positioning plane 12 of the base guide plate 10; the fixing nail sleeve buckle 14 is buckled on the fixing nail sleeve 11 so that the locating guide plate 13 is connected with the substrate guide plate 10.
the planting guide plate 16, repairing guide plate 19 and guide plate 13 are respectively provided with a connecting rod 18; the connecting rod 18 is connected with the fixing nail sleeve buckle 14.
the repairing guide plate 19 is provided with a repairing body; the repairing body is connected with the tongue side locating plane 15 and fixing nail sleeve buckle 14; when the prosthesis is finally planted, grinding the tongue side locating plane 15, fixing nail sleeve buckle 14 and a connecting rod 18.
further comprising an implant; implanting the implant through the implant sleeve 17; the implant is connected with a temporary abutment 21; The temporary abutment 21 is bonded to the prosthesis on the repair guide plate 19.

### Example 4

A method for using the dental support type guide plate in Embodiment 3;

a) the positioning guide plate and substrate guide plate are connected together (as shown in FIGS. 16-1 to 16-4), worn in the patient mouth, after confirming position according to the fixing nail sleeve 11 fixing nail, taking the guide plate 13;
b) removing the redundant teeth;
c) subsequently wearing the planting guide plate 16 according to the outer surface of the fixing nail sleeve 11 of the substrate guide plate 10 and positioning plane 12, and matching the positioning plane 12 of the substrate guide plate 10 with the tongue side positioning plane 15 of the planting guide plate 16; after wearing the planting guide plate 16, implanting the implant (as shown in FIGS. 17-1 to 17-4) through the implant sleeve 17;
d) after implanting the implant, taking off the planting guide plate 16; then installing temporary abutment 21 on the implant, and according to the substrate guide 10 of the fixing nail sleeve 11 outer surface and positioning plane 12 wearing repairing guide plate 19 (as shown in FIGS. 18-1 to 18-4), the substrate guide plate 10 of the locating plane 12 with the repairing guide plate 19 of the tongue side of the plane 15; after wearing the repairing guide plate 19, the temporary base station 21 and repairing guide plate are adhered together around the temporary base station;
e) after bonding, taking the temporary base and repairing guide plate 19, grinding the repairing guide plate 19 on the connecting rod 18, tongue side locating plane 15 and fixing nail sleeve buckle 14, leaving the prosthesis, and grinding the temporary abutment 21 of the upper end of the repairing guide plate;
f) taking off the substrate guide plate 10; wearing the prosthesis in the step e); fixing the temporary abutment and implant.

### Example 5

As shown in FIG. 1-1, a preparation method of mucosa supporting guide plate, comprising the following steps:

a) the blocking material 1 is adhered on the oral mucosa (as shown in FIG. 19), the blocking material is adhered on the dental arch mucosa or/and blocking material is bonded on the dental embankment; on the oral mucosa, at least 4 points bonding the blocking material on the dental arch mucous membrane or/and on the dental embankment;
b) carrying out CBCT shooting; obtaining CBCT data with the blocking material information (as shown in FIG. 8);
c) obtaining the oral surface STL data with impedance material information, the method comprising:
i. taking the oral impression; the blocking material will leave the mark on the corresponding position of the impression material; after the impression material is hard, the blocking material is reset to the impression; using the oral surface scanning device 6 to scan the oral impression; namely, obtaining STL data with the blocking material information (as shown in FIG. 20);
ii. or using an oral surface scanning device 7 to scan directly within the oral cavity, obtaining STL data with the information of the blocking material (as shown in FIG. 21);
iii. or bonding a barrier material at the thickest and thinnest part of the oral mucosa; and then displaying the bone and suspended barrier material information in the CBCT data according to CBCT; due to the suspended barrier material being adhered to the soft tissue, analyzing the barrier material and bone relationship; to analyze the relationship and thickness of the bone and mucosa, so as to obtain soft tissue information, finally obtaining STL data;
d) matching the CBCT data with the STL data: integrating the CBCT data and STL data, taking the information of the blocking material as the matching basis, by adjusting the tissue information in the CBCT data and STL data, finally making the jaw bone 8 information, soft tissue 9 information matched (as shown in FIG. 22);
e) determining the implant and retention pin position: according to the CBCT data and STL data matching information, obtaining the pre-tooth position and jaw position, then according to the pre-tooth position and jaw position, determining the implant and position of the fixing nail;
f) generating a substrate guide plate 10: according to the implant and fixing nail position, determining the position of the fixing nail sleeve 11 and position plane 12, the fixing nail sleeve 11 and positioning plane 12 are combined into a whole, obtaining the fixing nail sleeve 11 of the substrate guide 10 (as shown in FIGS. 12-1 to 12-4);
g) generating the planting guide plate 16:
i. determining the position of the retention pin sleeve buckle 14 and tongue side positioning plane 15 of the planting guide plate 16 according to the position of the retention pin sleeve 11 and positioning plane 12 of the base guide plate 10; the fixing nail sleeve buckle 14 of the planting guide plate 16 is matched with the fixing nail sleeve 11 of the substrate guide plate 10; the tongue side of the planting guide plate 16 is matched with the locating plane 12 of the substrate guide plate 10;
ii. designing the implant sleeve 17 and connecting rod 18 of the planting guide plate 16;
iii. the retention pin sleeve 14, the tongue side in position plane 15, the implant sleeve 17 and connecting rod 18 are integrally connected to form a planting guide 16 (as shown in FIGS. 14-1 to 14-2);
h) generating repair guide plate 19:
i. matching information according to CBCT data and STL data; performing virtual tooth arranging to obtain a prosthesis;
ii. The temporary abutment 21 is selected according to the selected implant, and temporary abutment 21 passes through the prosthesis;
iii. determining the position of the retention pin sleeve buckle 14 and tongue side in-position plane 15 of the repair guide plate 19 according to the position of the retention pin sleeve 11 and positioning plane 12 of the base guide plate 10; the fixing nail sleeve buckle 14 of the repairing guide plate 19 is matched with the fixing nail sleeve 11 of the substrate guide plate 10; the tongue side of the repairing guide plate 19 is matched with the locating plane 12 of the substrate guide plate 10;
iv. designing the connecting rod 18 of the repairing guide plate 19; connecting the repairing body of the repairing guide plate, the fixing nail sleeve buckle 14, the tongue side locating plane 15 and connecting rod 18 as a whole; generating the repairing guide plate 19 (as shown in FIGS. 15-1 to 15-2).
further comprising step i): the step f), g) and h) is generated in the substrate guide plate 10, planting guide plate 16 and repairing guide plate 19 output and for 3 D printing.

Preferably, the prosthesis is repairing dentition.

### Example 6

As shown in FIGS. 12-1 to 12-4, FIGS. 15-1 to 15-2, FIGS. 15-1 to 15-2 shown, a mucosa support type guide plate prepared by the preparation method of the mucosa support type guide plate according to embodiment 5; comprising a substrate guide plate 10, planting guide plate 16 and repairing guide plate 19;

a fixing nail sleeve 11 and a locating plane 12 are arranged on the substrate guide plate 10;
the planting guide plate 16 is provided with an implant sleeve 17, a fixing nail sleeve buckle 14 and a tongue side locating plane 15; the fixing nail sleeve buckle 14 is buckled on the fixing nail sleeve 11 so that the planting guide plate 16 is connected with the substrate guide plate 10; the tongue side positioning plane 15 of the planting guide plate 16 is matched with the positioning plane 12 of the substrate guide plate 10;
the repairing guide plate 19 is provided with a fixing nail sleeve buckle 14 and a tongue side locating plane 15; the fixing nail sleeve buckle 14 is buckled on the fixing nail sleeve 11 so that the repairing guide plate 19 is connected with the substrate guide plate 10; the tongue side positioning plane 15 of the repairing guide plate 19 is matched with the positioning plane 12 of the substrate guide plate 10;
the planting guide plate 16 and repairing guide plate 19 are respectively provided with a connecting rod 18; the connecting rod 18 is connected with the fixing nail sleeve buckle 14. the repairing guide plate 19 is provided with a repairing body; the repairing body is connected with the tongue side locating plane 15 and fixing nail sleeve buckle 14; when the prosthesis is finally planted, grinding the tongue side locating plane 15, fixing nail sleeve buckle 14 and a connecting rod 18.
further comprising an implant; implanting the implant through the implant sleeve 17; the implant is connected with a temporary abutment 21; The temporary abutment 21 is bonded to the prosthesis on the repair guide plate 19.

### Example 7

A method of using the mucosal support type guide plate in Example 6;

a) the substrate guide 10 is worn in the patient mouth, after confirming position according to the fixing nail sleeve 11 on the fixing nail;
b) subsequently wearing the planting guide plate 16 according to the outer surface of the fixing nail sleeve 11 of the substrate guide plate 10 and positioning plane 12, and matching the positioning plane 12 of the substrate guide plate 10 with the tongue side positioning plane 15 of the planting guide plate 16; after wearing the planting guide plate 16, implanting the implant (as shown in FIGS. 17-1 to 17-4) through the implant sleeve 17;
c) after implanting the implant, taking the planting guide plate 16; then installing temporary abutment 21 on the implant, and according to the substrate guide 10 of the fixing nail sleeve 11 outer surface and positioning plane 12 wearing repairing guide plate 19 (as shown in FIGS. 18-1 to 18-4), the substrate guide plate 10 of the locating plane 12 with the repairing guide plate 19 of the tongue side of the plane 15; after wearing the repairing guide plate 19, the temporary base station 21 and repairing guide plate are adhered together around the temporary base station;
d) after bonding, taking the temporary base and repairing guide plate 19, grinding the repairing guide plate 19 on the connecting rod 18, tongue side locating plane 15 and fixing nail sleeve buckle 14, leaving the prosthesis, and grinding the temporary abutment 21 of the upper end of the repairing guide plate;
e) taking off the substrate guide plate 10, wearing the prosthesis in step d), fixing the temporary abutment with the implant.

### Example 8

As shown in FIG. 1-2, a preparation method of bone supporting guide plate, comprising the following steps:

a) shooting CBCT to the jaw bone to obtain CBCT data;
b) determining the position of the implant and retention pin: according to the CBCT data and STL data matching information, obtaining the pre-tooth position and jaw position, then according to the pre-tooth position and jaw position, determining the implant and position of the fixing nail;
c) generating a substrate guide plate 10: according to the implant and fixing nail position, determining the position of the fixing nail sleeve 11 and position plane 12, the fixing nail sleeve 11 and positioning plane 12 are combined into a whole, obtaining the fixing nail sleeve 11 of the substrate guide 10 (as shown in FIGS. 12-1 to 12-4);
d) generating the planting guide plate 16:
i. determining the position of the retention pin sleeve buckle 14 and tongue side positioning plane 15 of the planting guide plate 16 according to the position of the retention pin sleeve 11 and positioning plane 12 of the base guide plate 10; the fixing nail sleeve buckle 14 of the planting guide plate 16 is matched with the fixing nail sleeve 11 of the substrate guide plate 10; the tongue side of the planting guide plate 16 is matched with the locating plane 12 of the substrate guide plate 10;
ii. designing the implant sleeve 17 and connecting rod 18 of the planting guide plate 16;
iii. the retention pin sleeve 14, the tongue side in position plane 15, the implant sleeve 17 and connecting rod 18 are integrally connected to form a planting guide 16 (as shown in FIGS. 14-1 to 14-2);
e) generating repair guide plate 19:
i. matching information according to CBCT data and STL data; performing virtual tooth arranging to obtain a prosthesis;
ii. The temporary abutment 21 is selected according to the selected implant, and temporary abutment 21 passes through the prosthesis;
iii. determining the position of the retention pin sleeve buckle 14 and tongue side in-position plane 15 of the repair guide plate 19 according to the position of the retention pin sleeve 11 and positioning plane 12 of the base guide plate 10; the fixing nail sleeve buckle 14 of the repairing guide plate 19 is matched with the fixing nail sleeve 11 of the substrate guide plate 10; the tongue side of the repairing guide plate 19 is matched with the locating plane 12 of the substrate guide plate 10;
iv. designing the connecting rod 18 of the repairing guide plate 19; connecting the repairing body of the repairing guide plate, the fixing nail sleeve buckle 14, the tongue side locating plane 15 and connecting rod 18 as a whole; generating the repairing guide plate 19 (as shown in FIGS. 15-1 to 15-2);
further comprising step f): the step c), d) and e) generated in the substrate guide plate 10, planting guide plate 16 and repairing guide plate 19 output and for 3 D printing.

Preferably, the prosthesis is repairing dentition.

### Example 9

As shown in FIGS. 12-1 to 12-4, FIGS. 15-1 to 15-2, FIGS. 15-1 to 15-2 shown, a bone support type guide plate prepared by the preparation method of the bone support type guide plate according to embodiment 8; comprising a substrate guide plate 10, planting guide plate 16 and repairing guide plate 19;

a fixing nail sleeve 11 and a locating plane 12 are arranged on the substrate guide plate 10;
the planting guide plate 16 is provided with an implant sleeve 17, a fixing nail sleeve buckle 14 and a tongue side locating plane 15; the fixing nail sleeve buckle 14 is buckled on the fixing nail sleeve 11 so that the planting guide plate 16 is connected with the substrate guide plate 10; the tongue side positioning plane 15 of the planting guide plate 16 is matched with the positioning plane 12 of the substrate guide plate 10;
the repairing guide plate 19 is provided with a fixing nail sleeve buckle 14 and a tongue side locating plane 15; the fixing nail sleeve buckle 14 is buckled on the fixing nail sleeve 11 so that the repairing guide plate 19 is connected with the substrate guide plate 10; the tongue side positioning plane 15 of the repairing guide plate 19 is matched with the positioning plane 12 of the substrate guide plate 10;
the planting guide plate 16 and repairing guide plate 19 are respectively provided with a connecting rod 18; the connecting rod 18 is connected with the fixing nail sleeve buckle 14.
the repairing guide plate 19 is provided with a repairing body; the repairing body is connected with the tongue side locating plane 15 and fixing nail sleeve buckle 14; when the prosthesis is finally planted, grinding the tongue side locating plane 15, fixing nail sleeve buckle 14 and a connecting rod 18.
further comprising an implant; implanting the implant through the implant sleeve 17; the implant is connected with a temporary abutment 21; The temporary abutment 21 is bonded to the prosthesis on the repair guide plate 19.

### Example 10

A method of using the bone-supporting guide plate in Example 9;

a) flap in the patient mouth, then wearing the substrate guide 10, confirming the position according to the fixing nail sleeve 11 fixing nail, then reference position plane 12 the jaw bone operation (as shown in FIG. 23);
b) subsequently wearing the planting guide plate 16 according to the outer surface of the fixing nail sleeve 11 of the substrate guide plate 10 and positioning plane 12, and matching the positioning plane 12 of the substrate guide plate 10 with the tongue side positioning plane 15 of the planting guide plate 16; after wearing the planting guide plate 16, implanting the implant (as shown in FIGS. 24-1 to 24-4) through the implant sleeve 17;
c) after implanting the implant, taking the planting guide plate 16; then installing temporary abutment 21 on the implant, and according to the substrate guide 10 of the fixing nail sleeve 11 outer surface and positioning plane 12 wearing repairing guide plate 19 (as shown in FIGS. 25-1 to 25-4), the substrate guide plate 10 of the locating plane 12 with the repairing guide plate 19 of the tongue side of the plane 15; after wearing the repairing guide plate 19, the temporary base station 21 and repairing guide plate are adhered together around the temporary base station;
d) after bonding, taking the temporary base and repairing guide plate 19, grinding the repairing guide plate 19 on the connecting rod 18, tongue side locating plane 15 and fixing nail sleeve buckle 14, leaving the prosthesis, and grinding the temporary abutment 21 of the upper end of the repairing guide plate;
e) taking off the substrate guide plate 10, suturing the patient mucosa, wearing the prosthesis in the step d), fixing the temporary abutment 21 and implant.

The above embodiments are not intended to be exhaustive or other embodiments. The above embodiments are intended to illustrate the present invention without limiting the scope of protection of the present invention. All applications made by the present invention in the scope of the present invention fall within the scope of the present invention.

The patent specification uses example to display the invention, wherein it comprises the best mode, and making the familiar with the technical personnel of the field manufacturing and using the invention. The scope of the invention may be authorized to include the contents of the claims and specific embodiments and other embodiments of the specification. These other examples should also fall within the scope of the patent claims of the present invention, as long as they contain the technical features described in the same written language according to the claims, or they contain the technical features described with respect to a similar word-like language that is not substantially different from the claims.

All patents, patent applications, and other reference documents are hereby incorporated by reference in their entirety. However, if one term in the present application is conflicted with the term which has been incorporated in the reference, the terms of the present application are preferred.

It should be noted that “first”, “second” or similar words do not represent any order, quality or importance, but is only used to distinguish different technical features. The number of modified words used in combination is “about” to contain the values and meaning specified by the context of the context. (For example: It contains errors in the measurement of a particular number).

1. A preparation method of tooth-borne guide plate, wherein the method comprises the following steps:
a) bonding a radiopaque material onto teeth, bonding the radiopaque material onto the gingival mucosa membrane or/and bonding the radiopaque material to other anatomical features;
b) performing CBCT photography to acquire CBCT data with radiopaque material information;
c) acquiring oral cavity surface STL data with radiopaque material information;
d) matching the CBCT data with the STL data;
e) determining the positions of an implant and a retention pin:
according to the matching information of the CBCT data and STL data, obtaining the pre-aligned tooth position and jawbone position, then determining the positions of the implant and retention pin according to the pre-aligned tooth position and jawbone position;
f) generating a base guide plate:
determining the positions of the retention pin sleeve and in-place plane according to the positions of the implant and retention pin, combining the retention pin sleeve and in-place plane as a whole body to obtain a base guide plate with the retention pin sleeve;
g) generating in-place guide plate;
i. generating in-place guide plate main body portion according to the STL data;
according to the positions of the retention pin sleeve and in-place plane of the base guide plate, determining the positions of the retention pin sleeve buckle and tongue side in-place plane of in-place guide plate;
such that the retention pin sleeve buckle of in-place guide plate is matched with the retention pin sleeve of the base guide plate, and such that the tongue side in-place plane of in-place guide plate is matched with in-place plane of the base guide plate;
iii, connecting in-place guide plate main body part with the retention pin sleeve buckle and tongue side in-place plane to form a whole body so as to generate in-place guide plate;
h) generating an implant guide plate:
i. determining the positions of the retention pin sleeve buckle and tongue side in-place plane of the implant guide plate according to the positions of the retention pin sleeve and in-place plane of the base guide plate;
such that the retention pin sleeve buckle of the implant guide plate is matched with the retention pin sleeve of the base guide plate, and such that the tongue side in-place plane of the implant guide plate is matched with in-place plane of the base guide plate;
ii. designing implant sleeve and connecting rod for implant guide plate;
iii. connecting the retention pin sleeve buckle, the tongue side in-place plane, the implant sleeve and connecting rod as a whole so as to generate implant guide plate;
i) generating a repair guide plate:
i. matching information according to the CBCT data and STL data, performing virtual tooth alignment to obtain a prosthesis;
ii. selecting a temporary abutment according to the selected implant, and temporary abutment penetrates the prosthesis;
iii. determining the positions of the retention pin sleeve buckle and tongue side in-place plane of the repair guide plate according to the positions of the retention pin sleeve and in-place plane of the base guide plate;
such that the retention pin sleeve buckle of the repair guide plate is matched with the retention pin sleeve of the base guide plate, and such that the tongue side in-place plane of the repair guide plate is matched with in-place plane of the base guide plate;
iv. designing the connecting rod of the repair guide plate, connecting the prosthesis, the retention pin sleeve buckle, the tongue side in-place plane and connecting rod of the repair guide plate as a whole body so as to generate the repair guide plate.

2. The preparation method of dental support type guide plate according to claim 1, wherein further comprising step j):
the step f), g), h) and i) generated in the substrate guide plate;
the guide plate, planting guide plate and repairing guide output and for 3 D printing.

3. The preparation method of dental support type guide plate according to claim 1, wherein Other anatomical features include nasal crest, mucosal turning, bone protrusion, tongue protuberance.

4. The preparation method of dental support type guide plate according to claim 1, wherein on the tooth, at least 4 point bonding resistance material on the gingival mucosa or/and other anatomical features.

5. The preparation method of dental support type guide plate according to claim 1, wherein the method for obtaining the oral surface STL data with the impedance material information comprises:
a) taking the oral impression;
the blocking material will leave the mark on the corresponding position of the impression material;
after the mould is hard to be printed, the blocking material is reset to the impression;
using the oral surface scanning device to scan the oral cavity impression;
namely, obtaining STL data with the blocking material information;
b) or using oral surface scanning device to directly scan in the oral cavity;
obtaining STL data with anti-reflection material information;
c) or bonding the barrier material at the thickest and thinnest part of the oral mucosa, then displaying the bone in the CBCT data according to CBCT;
tooth information and suspended resistance material information;
because the suspension of the impedance material is adhered on the soft tissue, by analyzing the impedance material and bone relation, it can analyze the relationship and thickness of the bone and mucosa, so as to obtain soft tissue information, finally obtaining STL data.

6. The preparation method of dental support type guide plate according to claim 1, wherein the matching of the CBCT data with the STL data includes:
integrating the CBCT data and STL data, taking the information of the blocking material as the matching basis, by adjusting the tooth tissue information in the CBCT data and STL data, finally matching the jaw bone information, tooth tissue information, soft tissue information.

7. The preparation method of dental support type guide plate according to claim 1, wherein the prosthesis is a repair dentition.

8. A dental support type guide plate prepared by the preparation method of dental support type guide plate according to claim 1, wherein the dental support type guide plate comprises:
a substrate guide plate, a planting guide plate, a repairing guide plate and a positioning guide plate;
a fixing nail sleeve and a locating plane are arranged on the substrate guide plate;
the planting guide plate is provided with an implant sleeve, a fixing nail sleeve buckle and a tongue side locating plane;
the fixing nail sleeve is buckled on the fixing nail sleeve so that the planting guide plate is connected with the substrate guide plate;
the tongue side locating plane of the planting guide plate is matched with the locating plane of the substrate guide plate;
a fixing nail sleeve buckle and a tongue side locating plane are arranged on the repairing guide plate;
the fixing nail sleeve is buckled on the fixing nail sleeve so that the repairing guide plate is connected with the substrate guide plate;
the tongue side locating plane of the repairing guide plate is matched with the locating plane of the substrate guide plate;
the locating guide plate is provided with a fixing nail sleeve buckle and a tongue side locating plane;
the tongue side locating plane is matched with the locating plane of the substrate guide plate;
the fixing nail sleeve is buckled on the fixing nail sleeve so that the positioning guide plate is connected with the substrate guide plate.

9. The dental support guide plate according to claim 8, wherein the planting guide plate, repairing guide plate and locating guide plate are respectively provided with a connecting rod;
the connecting rod is connected with the fixing nail sleeve buckle;
wherein the repairing guide plate is provided with a repairing body;
the repairing body is connected with the tongue side locating plane and fixing nail sleeve buckle;
when the repairing body is finally planted, grinding the tongue side locating plane, fixing nail sleeve buckle and connecting rod;
the dental support guide plate further comprising:
an implant;
implanting the implant through the implant sleeve;
the implant is connected with a temporary base;
the temporary base is bonded with the repairing body on the repairing guide plate.

10. (canceled)

11. (canceled)

12. (canceled)

13. A preparation method of mucosal support type guide plate, wherein the method comprises the following steps:
a) the blocking material is adhered on the oral mucosa, the blocking material is adhered on the dental arch mucous membrane or/and blocking material is adhered on the dental embankment;
b) carrying out CBCT shooting;
obtaining CBCT data with anti-reflection material information;
c) obtaining the oral surface STL data with the anti-reflection material information;
d) matching CBCT data with STL data;
e) determining the implant and retention pin position:
according to the CBCT data and STL data matching information, obtaining the pre-tooth position and jaw position, then according to the pre-tooth position and jaw position, determining the implant and position of the fixing nail;
f) generating a substrate guide:
determining the position of the fixing nail sleeve and positioning plane according to the implant and fixing nail position;
combining the fixing nail sleeve and positioning plane into a whole body;
obtaining the substrate guide plate with the fixing nail sleeve;
g) generating a planting guide plate:
i. determining the position of the fixing nail sleeve buckle and tongue side position plane of the planting guide plate according to the position of the fixing nail sleeve and positioning plane of the base guide plate;
the fixing nail sleeve buckle of the planting guide plate is matched with the fixing nail sleeve of the substrate guide plate;
the tongue side of the planting guide plate is matched with the locating plane of the substrate guide plate;
ii, designing implant sleeve and connecting rod for planting guide plate;
iii, the fixing nail sleeve buckle, tongue side locating plane;
the implant sleeve and connecting rod are connected as a whole, generating planting guide plate;
h) generating a repair guide plate:
i. matching information according to CBCT data and STL data;
performing virtual tooth arranging to obtain a prosthesis;
ii. selecting a temporary abutment according to the selected implant, and temporary abutment penetrates the prosthesis;
determining the position of the fixing nail sleeve buckle and tongue side position plane of the repairing guide plate according to the position of the fixing nail sleeve and locating plane of the substrate guide plate;
the fixing nail sleeve buckle of the repairing guide plate is matched with the fixing nail sleeve of the substrate guide plate;
the tongue side of the repairing guide plate is matched with the locating plane of the substrate guide plate;
iv. designing the connecting rod of the repairing guide plate;
connecting the repairing body of the repairing guide plate, the fixing nail sleeve buckle, the tongue side locating plane and connecting rod into a whole body;
generating the repairing guide plate.

14. The preparation method of mucosa supporting guide plate according to claim 13, wherein further comprising step i):
the step f), g) and h) generating the substrate guide plate, planting guide plate and repairing guide output and performing the 3 D printing

15. The preparation method of mucosa supporting guide plate according to claim 13, wherein on the oral mucosa, at least 4 point bonding resistance material on the dental arch mucosa or/and on the dental dyke.

16. The preparation method of mucosa supporting guide plate according to claim 13, wherein the method for obtaining the oral surface STL data with the impedance material information comprises:
a) taking the oral cavity impression;
the blocking material will leave the mark on the corresponding position of the impression material;
after the mould is hard to be printed, copying the blocking material to the impression;
using the oral surface scanning device to scan the oral impression;
obtaining the STL data with the information of the blocking material;
b) or using oral surface scanning device to directly scan in the oral cavity;
obtaining STL data with anti-reflection material information;
c) or bonding the barrier material at the thickest and thinnest part of the oral mucosa;
then according to CBCT, the CBCT data displays the bone and suspended barrier material information;
because the suspended barrier material is adhered on the soft tissue, by analyzing the barrier material and bone relation, the relation and thickness of the bone and mucosa can be analyzed;
so as to obtain soft tissue information, finally obtaining STL data.

17. The preparation method of mucosa supporting guide plate according to claim 13, wherein the matching of the CBCT data with the STL data includes:
integrating the CBCT data and STL data, taking the information of the blocking material as the matching basis, by adjusting the tissue information in the CBCT data and STL data, finally matching the jaw bone information and soft tissue information.

18. The preparation method of mucosa supporting guide plate according to claim 13, wherein the prosthesis is a repair dentition.

19. A mucosal support type guide plate prepared by the preparation method of the mucosal support type guide plate according to claim 13, wherein the mucosal support type guide late comprises:
a substrate guide plate, a planting guide plate and a repairing guide plate;
a fixing nail sleeve and a locating plane are arranged on the substrate guide plate;
the planting guide plate is provided with an implant sleeve, a fixing nail sleeve buckle and a tongue side locating plane;
the fixing nail sleeve is buckled on the fixing nail sleeve so that the planting guide plate is connected with the substrate guide plate;
the tongue side locating plane of the planting guide plate is matched with the locating plane of the substrate guide plate;
a fixing nail sleeve buckle and a tongue side locating plane are arranged on the repairing guide plate;
the fixing nail sleeve is buckled on the fixing nail sleeve so that the repairing guide plate is connected with the substrate guide plate;
the tongue side locating plane of the repairing guide plate is matched with the locating plane of the substrate guide plate.

20. The mucosal support type guide plate according to claim 19, wherein the planting guide plate and repairing guide plate are respectively provided with a connecting rod;
the connecting rod is connected with the fixing nail sleeve buckle;
wherein the repairing guide plate is provided with a repairing body;
the repairing body is connected with the tongue side locating plane and fixing nail sleeve buckle;
when the repairing body is finally planted, grinding the tongue side locating plane, fixing nail sleeve buckle and connecting rod;
the mucosal support type guide plate further comprising:
an implant;
implanting the implant through the implant sleeve;
the implant is connected with a temporary base;
the temporary base is bonded with the repairing body on the repairing guide plate.

21. (canceled)

22. (canceled)

23. (canceled)

24. A preparation method of bone supporting guide plate, wherein the method comprises the following steps:
a) shooting CBCT to the jaw bone to obtain CBCT data;
b) determining the position of the implant and retention pin:
obtaining the pre-tooth position and jaw position according to the obtained CBCT data;
then according to the pre-tooth position and jaw position, determining the implant and position of the fixing nail;
c) generating a substrate guide plate;
determining the position of the fixing nail sleeve and positioning plane according to the implant and fixing nail position;
combining the fixing nail sleeve and positioning plane into a whole body;
obtaining the substrate guide plate with the fixing nail sleeve;
d) generating a planting guide plate:
i. determining the position of the fixing nail sleeve buckle and tongue side position plane of the planting guide plate according to the position of the fixing nail sleeve and positioning plane of the base guide plate;
the fixing nail sleeve buckle of the planting guide plate is matched with the fixing nail sleeve of the substrate guide plate;
the tongue side of the planting guide plate is matched with the locating plane of the substrate guide plate;
iith, designing implant sleeve and connecting rod for planting guide plate;
iii, the fixing nail sleeve buckle, tongue side locating plane;
the implant sleeve and connecting rod are connected as a whole, generating planting guide plate;
e) generating a repair guide plate:
i. matching information according to CBCT data and STL data;
performing virtual tooth arranging to obtain a prosthesis;
ii. selecting a temporary abutment according to the selected implant, and temporary abutment penetrates the prosthesis;
determining the position of the fixing nail sleeve buckle and tongue side position plane of the repairing guide plate according to the position of the fixing nail sleeve and locating plane of the substrate guide plate;
the fixing nail sleeve buckle of the repairing guide plate is matched with the fixing nail sleeve of the substrate guide plate;
the tongue side of the repairing guide plate is matched with the locating plane of the substrate guide plate;
designing the connecting rod of the repairing guide plate;
the repairing body of the repairing guide plate, fixing nail sleeve buckle;
the tongue side locating plane and connecting rod are connected as a whole, generating repairing guide plate.

25. The preparation method of bone supporting guide plate according to claim 24, wherein further comprising step f):
the step c), d) and e) generated in the substrate guide plate, planting guide plate and repairing guide output and for 3 D printing.

26. The preparation method of bone supporting guide plate according to claim 24, wherein the prosthesis is a repair dentition.

27. A bone-supporting guide plate prepared by the preparation method of bone-supporting guide plate according to claim 24, wherein the bone-supporting guide plate comprises:
a substrate guide plate, a planting guide plate and a repairing guide plate;
a fixing nail sleeve and a locating plane are arranged on the substrate guide plate; the planting guide plate is provided with an implant sleeve, a fixing nail sleeve buckle and a tongue side locating plane;
the fixing nail sleeve is buckled on the fixing nail sleeve so that the planting guide plate is connected with the substrate guide plate;
the tongue side locating plane of the planting guide plate is matched with the locating plane of the substrate guide plate;
a fixing nail sleeve buckle and a tongue side locating plane are arranged on the repairing guide plate;
the fixing nail sleeve is buckled on the fixing nail sleeve so that the repairing guide plate is connected with the substrate guide plate;
the tongue side locating plane of the repairing guide plate is matched with the locating plane of the substrate guide plate.

28. The bone supporting guide plate according to claim 27, wherein the planting guide plate and repairing guide plate are respectively provided with a connecting rod;
the connecting rod is connected with the fixing nail sleeve buckle;
wherein the repairing guide plate is provided with a repairing body;
the repairing body is connected with the tongue side locating plane and fixing nail sleeve buckle;
when the repairing body is finally planted, grinding the tongue side locating plane, fixing nail sleeve buckle and connecting rod;
the bone support guide plate further comprising:
an implant;
implanting the implant through the implant sleeve;
the implant is connected with a temporary base;
the temporary base is bonded with the repairing body on the repairing guide plate.

29. (canceled)

30. (canceled)

31. (canceled)
